(19) United States
(12) Patent Application Publication
(10) Pub. No.: US 2015/0095186 A1
(43) Pub. Date: Apr. 2, 2015

(54) FLEXIBLE SPENDING ACCOUNT PROVISION SYSTEM

(71) Applicants: Jayasree Mekala, Austin, TX (US); Kamal Zamer, Austin, TX (US); Satish V. Kumar, San Jose, CA (US); Joseph Vernon Paulson, San Jose, CA (US); Praveen Nuthulapati, San Jose, CA (US)

(72) Inventors: Jayasree Mekala, Austin, TX (US); Kamal Zamer, Austin, TX (US); Satish V. Kumar, San Jose, CA (US); Joseph Vernon Paulson, San Jose, CA (US); Praveen Nuthulapati, San Jose, CA (US)

(21) Appl. No.: 14/041,633

(22) Filed: Sep. 30, 2013

(51) Int. Cl. G06Q 20/38; G06Q 20/14

(52) U.S. Cl. CPC G06Q 20/38; G06Q 20/14
USPC 705/26.8

(57) ABSTRACT

Systems and methods for providing a flexible spending account (FSA) include receiving, from a user, user information and a purchase request to make a purchase from a merchant. A payment is then made for at least a portion of the purchase by transferring funds over the network from a user FSA to a merchant account. Payment detail information such as, for example, a receipt, is then received over the network from the merchant in response to making the payment. The payment detail information is then sent over the network to an FSA provider that provides the user FSA. If the FSA provider analyzes the payment detail information and determines that the payment made using the user FSA includes an item that is an unqualified expense, funds from a user secondary account may be transferred to the user FSA to reimburse the user FSA.

### BACKGROUND

1. Field of the Invention

The present disclosure generally relates to online and/or mobile payments and more particularly to systems and methods for providing a flexible spending account.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Flexible spending accounts (FSAs) are tax-advantaged accounts for employees that are set up through an employer such that the employer sets aside a portion of the employees earnings, which are not subject to payroll taxes, to pay for qualified expenses such as, for example, medical expenses, dental expenses, dependent care expenses, and/or a variety of other qualified expenses known in the art. Conventionally, FSA purchases have not taken advantage of online and/or mobile payment systems. Instead, users of a FSA are typically issued an FSA payment card, similar to a debit card, which the user may use to pay for purchases with their FSA. However, on many occasions, purchases made using an FSA must be verified by an FSA provider to ensure that those purchases are for qualified expenses. This is typically accomplished by having the user mail in receipts for the purchases to the FSA provider so that the FSA provider can determine whether each item associated with the purchases are for qualified expenses for the FSA. If any items associated with the purchases are not qualified expenses, the user is informed of such, and required to transact a reimbursement payment from a personal account, through the FSA provider, and to the FSA. In addition, FSAs are typically subject to a “use it or lose it” provision that causes the user to forfeit any FSA funds unspent during the year. These systems and methods for making payments using FSAs can be cumbersome and time consuming for the user, and result in many users electing to forgo FSA accounts, despite their advantages.

Thus, there is a need for an improved flexible spending account provision system.

### BRIEF DESCRIPTION OF THE FIGURES

FIG. 1 is a flow chart illustrating an embodiment of a method for providing a flexible spending account;

FIG. 2 is a screen shot illustrating an embodiment of a user device displaying a payment method selection screen;

FIG. 3 is a screen shot illustrating an embodiment of a user device displaying a bill screen;

FIG. 4 is a screen shot illustrating an embodiment of a user device displaying a payment method selection screen;

FIG. 5 is a screen shot illustrating an embodiment of a user device displaying a bill screen;

FIG. 6 is a screen shot illustrating an embodiment of a user device displaying an user FSA information screen;

FIG. 7 is a schematic view illustrating an embodiment of a networked system;

FIG. 8 is a perspective view illustrating an embodiment of a user device;

FIG. 9 is a schematic view illustrating an embodiment of a computer system; and

FIG. 10 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing flexible spending accounts (FSAs) that operate to make the use and management of FSAs easier such that the benefits of FSAs may be realized by a greater number of users relative to conventional FSA provisioning systems, discussed above. In one embodiment, a payment service provider operates to manage a user FSA, provided by an FSA provider to a user, by associating user information with the user FSA in a database. When the user provides the user information along with a purchase request to make a purchase for an FSA qualified expense, the payment service provider may review the purchase request to determine that the FSA qualified expense is associated with the purchase and, in response, pay for the purchase by transferring funds from the user FSA to a merchant account. The payment service provider then also operates to retrieve payment detail information (e.g., a receipt) for the payment from the merchant, and provides that payment detail information to the FSA provider to verify that the purchase paid for with the user FSA was for a qualified expense. If, following the payment to the merchant account from the user FSA, the FSA provider indicates to the payment service provider that any portion of the payment made using the user FSA was for an unqualified expense, the payment service provider may then transfer funds from a secondary user account to the user FSA to reimburse the user FSA. Payment detail information is stored in the database, and user FSA information that may include any of a plurality of different payment detail information associated with different payments made using the user FSA, a user FSA balance, time periods associated with forfeiture of the user FSA balance, and/or a variety of other user FSA information may be provided to the user so that the user is able to quickly and easily make decisions about how to optimally use their user FSA.

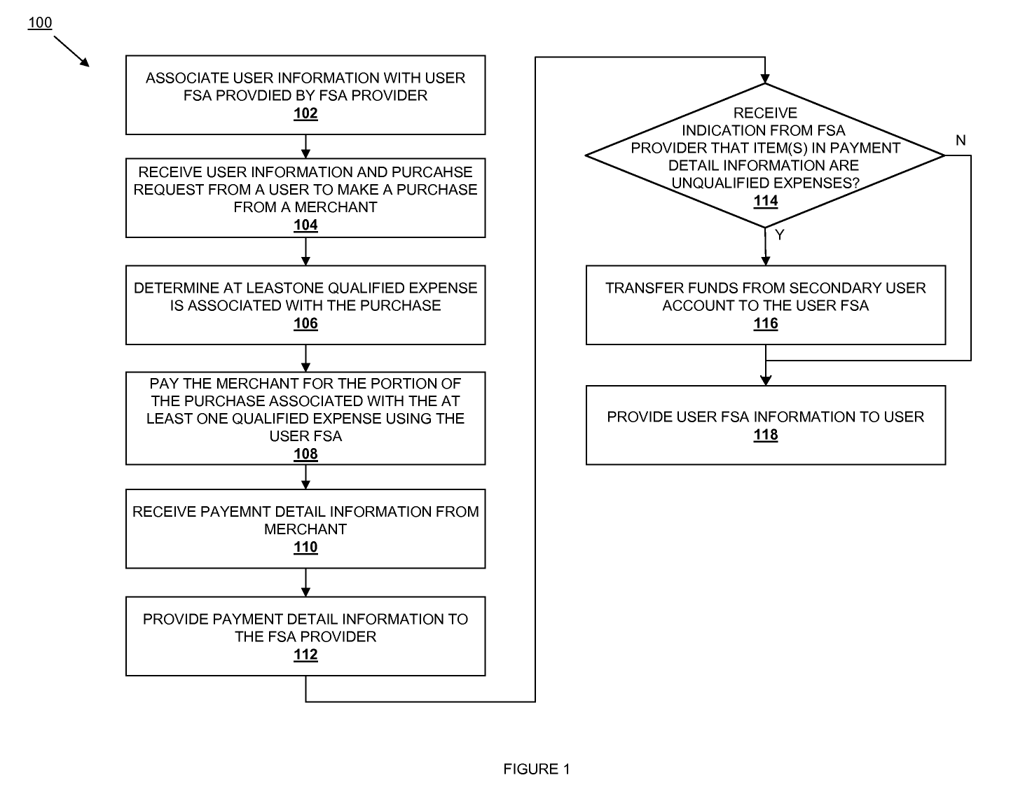

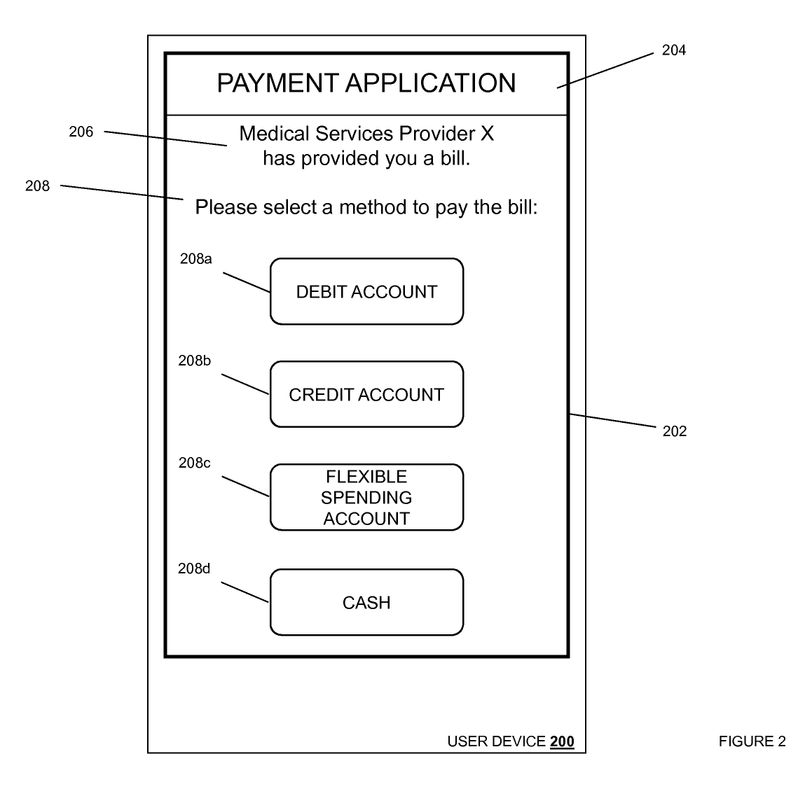

Referring now to FIGS. 1 and 2, an embodiment of a method 100 for providing FSAs is illustrated. In the embodiments illustrated and discussed below, a payment service provider such as, for example, PayPal Inc. of San Jose, Calif. operates between a user and an FSA provider to manage a user FSA provided to the user by the FSA provider. For example, the payment service provider may provide a user payment service provider account to the user that links to the user FSA and one or more secondary user accounts such as checking accounts, savings accounts, credit accounts, and/or a variety of other funding accounts provided to the user by account providers. Furthermore, the payment service provider may also provide a secondary user account to the user. Thus, the payment service provider may store information about the user, the FSA account, and any secondary user accounts linked to the user payment service provider account such that funds may be transferred to and/or from any of those accounts in response to instructions received by the user. In other embodiments, the payment service provider or other system provider may provide the user FSA to the user and, as such, the payment service/system provider and the FSA provider discussed herein may, in some embodiments, be the same entity.

The method 100 begins at block 102 where user information is associated with a user FSA provided to the user by an FSA provider. As discussed above, a payment service provider may provide the user with a user payment service provider account, and at block 102, the user may link that user payment service provider account with a user FSA provided to the user by an FSA provider. For example, the user may open user FSA with the FSA provider, and at block 502, the user may link that user FSA to the user payment service provider account by sending, from a user device to a payment service provider device over a network, information related to the user FSA that includes, for example, an FSA provider identifier, a user FSA number, user FSA access information (e.g., a user name and password), and/or a variety of other FSA information known in the art. Upon receiving that information, the payment service provider device may use that information in communications with an FSA provider device to link the user FSA with the user payment service provider account using account linking methods known in the art. Upon linking the user FSA with the user payment service provider account, the payment service provider device (or other system provider device) includes user information (e.g., a user payment service provider account identifier, a user mobile phone number, a user name, a user password, and/or other user information known in the art) associated with the user FSA (e.g., a user FSA identifier, a user name, a user password, and/or other user FSA information known in the art) linked in a database stored in a non-transitory, computer-readable medium. In other embodiments where the payment service provider or other system provider provides the user FSA to the user, at block 102 the user may simply open the user FSA with the system provider, and the system provider will associate user information (e.g., used to open the user FSA) with the user FSA in a database.

Referring now to FIGS. 1, 2, 3, 4, and 5, the method 100 then proceeds to block 104 where user information and a purchase request to make a purchase from a merchant are received from a user. In the embodiments illustrated below, a user employs a mobile user device to send purchase requests to make purchases from a merchant to the payment service provider device or other system provider device. However, in other embodiments, the purchase request may be sent using other payment devices including, for example, payment cards (e.g., debit cards, credit cards, and/or other payment cards known in the art, used in conjunction with a merchant device), relatively non-mobile user devices such as desktop computers, and/or using a variety of other payment devices known in the art. Furthermore, in the embodiments illustrated and discussed below, the purchase request received from the user is for a purchase to be made from a merchant that is a medical services provider (e.g., a doctor or other medical services provider known in the art) or a pharmacy. However, one skilled in the art of FSAs will recognize that a wide variety of merchants other than those illustrated and described below may offer products and/or services (hereinafter “items”) that may be qualified expenses for a FSA, and thus the purchase request received from the user at block 104 may be for a purchase from any of those merchants as well.

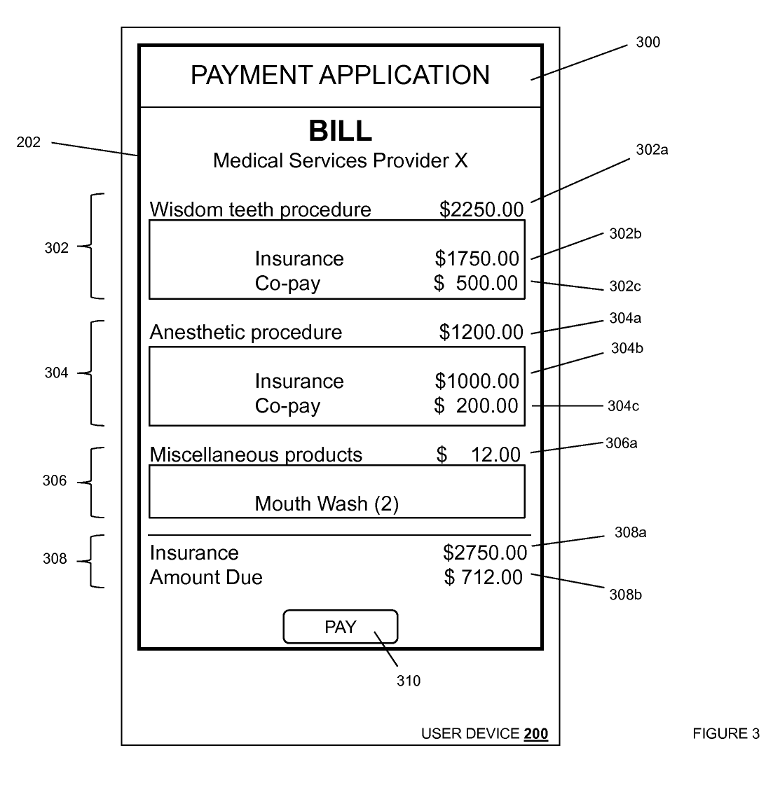

Referring first to FIGS. 2 and 3, at block 104 the user device may communicate with a merchant device to receive a bill. In an embodiment, a user may enter a merchant location (e.g., a physical merchant location such as a doctor's office, an online merchant location such as a payment website for a doctor's office, etc.) and receive a bill from a merchant device for a medical service performed (e.g., on the user, on a dependent of the user, or on any other user for which the user is to pay for the medical service.) For example, the user may have undergone a medical service, and at block 104 the merchant device of the medical service provider may provide a bill over a network (e.g., the Internet) to a user device of the user. In other non-illustrated embodiments, the user may be provided a bill and may present a payment card or other payment device to the merchant for use with a merchant device processing the payment.

FIG. 2 illustrates a user device 200 that includes a display 202 displaying a payment method selection screen 204 in response to receiving a bill from a merchant device over the network. For example, the payment method selection screen 204 may be associated with a user payment service provider account provided by the payment service provider to the user, and allows the user to select a funding account that is linked to the user payment service provider account to fund purchases made by the user. The payment method selection screen 204 may be provided by a payment application running on the user device 200 that operates to display the payment method selection screen 204 in response to the payment service provider device receiving a bill for the user from the merchant device. However, in other examples, the payment method selection screen 204 may be provided on a web page of a website of the merchant that the user device accesses over the network (e.g., by accessing a user account provided by the merchant and available for paying bills from the merchant through the website), and pays bills presented to the user using the user payment service provider account.

The payment method selection screen 204 includes an indication 206 that a bill has been received from the merchant, along with an instruction 208 to select a method to pay the bill, and several payment method selectors 208a, 208b, 208c, and 208d. As discussed above, some of the payment method selectors 208a-c may be for funding accounts linked to a user payment service provider account, and in the illustrated embodiment include a debit account selector 208a for a debit account linked to the user payment service provider account, a credit account selector 208b for a credit account linked to the user payment service provider account, and an FSA account selector 208c for an FSA account linked to the user payment service provider account. In addition, a cash selector 208d is provided to allow the user to indicate that the payment for the bill will be made in cash. While a few examples have been provided, one of skill in the art will recognize that any payment method may be available to the user to pay for the bill received from the merchant device. The user may use the payment method selection screen 204 to select any of a plurality of payment methods for paying the bill received from the merchant device. As such, the user may select a user FSA to pay for the bill by selecting the FSA selector 208c, or may select a non-FSA to pay for the bill by selecting the selectors 208a, 208b, or 208d, and that selection will be stored by the payment service provider device. As discussed above, in non-illustrated embodiments, the user may be presented with a bill (e.g., on a merchant device at a merchant location, through the mail, etc.) and may provide a particular account to pay for that bill by providing a payment card or payment details to the merchant (e.g., over the phone, over a website, etc.)

As discussed in further detail below, the payment service provider or system provider may operate to determine whether items in a bill received from the merchant are qualified expenses for a user FSA. As such, a user may designate a non-FSA to pay for the bill, and in some examples the payment service provider device or system provider device may detect items in the bill that are FSA qualified expenses and inform the user that those items may be paid for using the user FSA, or in other examples may operate to automatically pay for those items using the user FSA (e.g., despite the selection of a non-FSA account.) Similarly, the user may designate the user FSA to pay for the bill, and in some examples the payment service provider device or system provider device may detect items in the bill that are not FSA qualified expenses and inform the user that those items should be paid for using non-FSAs, or in other examples may operate to automatically pay for those items using non-FSAs of the user (e.g., despite the selection of an FSA account.) Thus, in some embodiments, the user may be informed which items in a bill are FSA qualified expenses and which items in a bill are not FSA qualified expenses, and may confirm or deny the use of the user FSA to pay for the qualified expenses.

Referring now to FIG. 3, the user device 200 is illustrated displaying a bill screen 300 for the bill received from the merchant device. The bill screen 300 includes a plurality of item details 302, 304, and 306, as well as a payment due section 308. The item details 302 includes details for a medical procedure 302a that, in the illustrated embodiment, is a wisdom teeth procedure for which a $2250.00 total charge is associated, along with a charge breakdown section that includes a first portion 302b of the total charge 302a ($1750.00) for the medical procedure 302a that is covered by an insurance provider of the user, and a portion 302c of the total charge 302a ($500.00) that is the responsibility of the user (e.g., the required “co-pay” for the user's insurance for the medical procedure 302a.) The item details 304 includes details for a medical procedure 304a that, in the illustrated embodiment, is an anesthetic procedure for which a $1200.00 total charge is associated, along with a charge breakdown section that includes a first portion 304b of the total charge 304a ($1000.00) for the medical procedure 304a that is covered by an insurance provider of the user, and a portion 304c of the total charge 304a ($200.00) that is the responsibility of the user (e.g., the required “co-pay” for the user's insurance for the medical procedure 304a.) The item details 306 includes details for items provided to the user that, in the illustrated embodiment, include 2 bottles of mouthwash for which a $12.00 total charge 306a is associated.

The payment due section 308 includes an insurance payment amount 308a ($2750.00) that is determined by adding the portions 302b and 304b of the total charges 302a and 304a, respectively, covered by the insurance provider of the user, and a user payment amount 308b that is determined by adding the portions 302c and 304c of the total charges 302a and 304a, respectively, along with the total charge 306a, that are the responsibility of the user. Thus, the bill received by the user details a plurality of items and different costs associated with those items, and as discussed below, some of those items may be qualified expenses for which payment using an FSA is allowed, while some of those items may be unqualified expenses for which payment using an FSA is not allowed. For example, qualified expenses for which payment using an FSA is allowed may include dental expenses that are not paid for by insurance (e.g., deductibles, copayments, and coinsurance for the user's insurance), and thus in the illustrated embodiment, the portions 302c and 304c of the total charges 302a and 304a, respectively, that are the responsibility of the user may be qualified expenses for which payment using the user FSA is allowed, while the total charge 306a may be an unqualified expense for which payment using the user FSA is not allowed.

At block 104 of the method 100, the user may select a pay button 310 provided on the bill screen 300 to send a purchase request to make a purchase from the merchant that provides an instruction to the payment service provider to pay the user payment amount 308b of the bill, discussed in further detail below. In an embodiment, the selection of the payment method using the payment method selection screen 204 and the selection of the pay button 310 on the bill screen 300 results in the user device 200 sending an instruction over the network to the payment service provider device or system provider device that includes user information (e.g., a user name, user password, user payment service provider account identifier, mobile user device phone number, and/or a variety of other user information known in the art) and a purchase request to make the purchase from the merchant that may include merchant information (e.g., identifying the merchant, a merchant account, information associated with the bill, etc.) and the payment method selected.

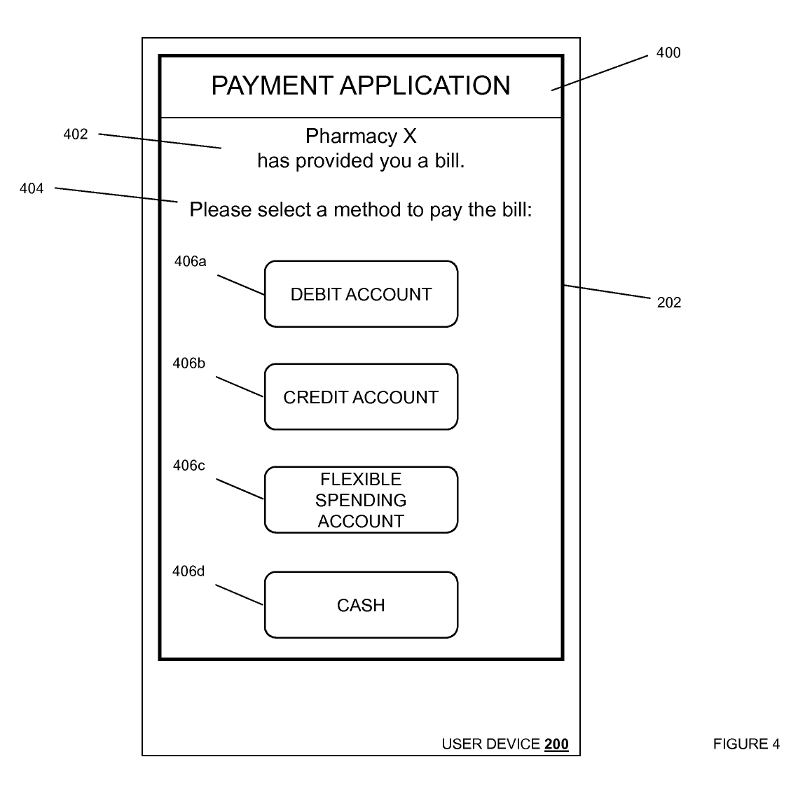

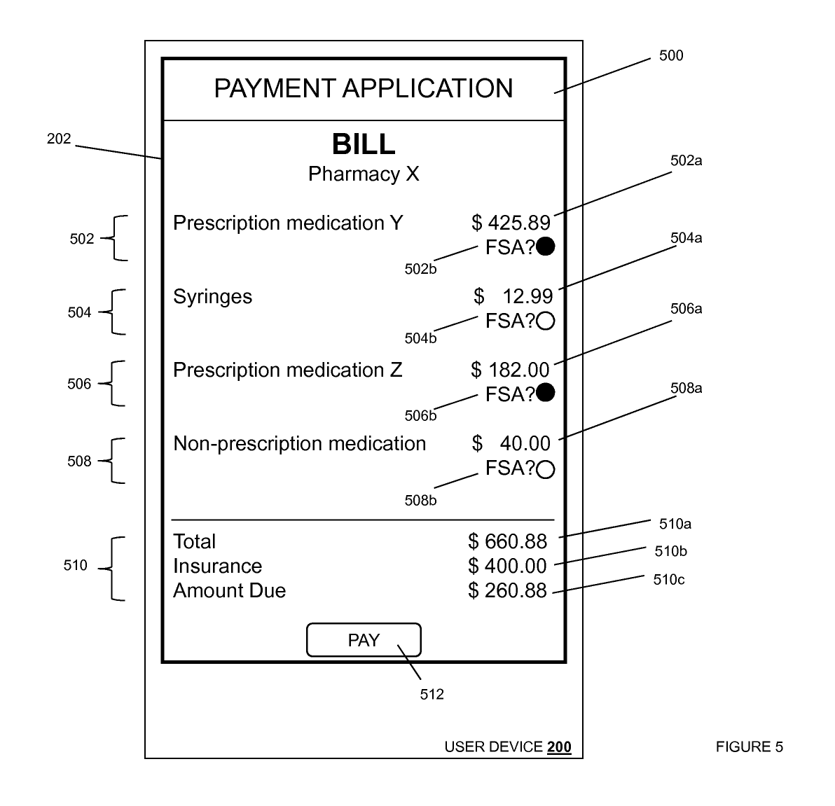

Referring next to FIGS. 4 and 5, another embodiment of block 104 is illustrated in which the user device communicates with a merchant device to receive a bill. In this embodiment, a user may enter a merchant location (e.g., a physical merchant location such as a pharmacy, an online merchant location such as a payment website for an on-line pharmacy, etc.) and receive a bill from a merchant device for medical items provided (e.g., to the user, to a dependent of the user, etc.) For example, the user may go to a pharmacy, and at block 104 the merchant device of the pharmacy may provide a bill over a network (e.g., the Internet) to a user device of the user. In other non-illustrated embodiments, the user may be provided a bill and may present a payment card or other payment device to the merchant for use with a merchant device processing the payment.

FIG. 4 illustrates the user device 200 that displaying a payment method selection screen 400 in response to receiving a bill from a merchant device over the network. For example, the payment method selection screen 400 may be associated with a user payment service provider account provided by the payment service provider to the user, and allows the user to select a funding account that is linked to the user payment service provider account to fund purchases made by the user. The payment method selection screen 400 may be provided by a payment application running on the user device 200 that operates to display the payment method selection screen 400 in response to the payment service provider device receiving a bill for the user from the merchant device. However, in other examples, the payment method selection screen 400 may be provided on a web page of a website of the merchant that the user device accesses over the network (e.g., by accessing a user account provided by the merchant and available for paying bills from the merchant through the website) and pays via the user payment service provider account.

The payment method selection screen 400 includes an indication 402 that a bill has been received from the merchant, along with an instruction 404 to select a method to pay the bill, and several payment method selectors 406a, 406b, 406c, and 406d. As discussed above, some of the payment method selectors 406a-c may be for funding accounts linked to a user payment service provider account, and in the illustrated embodiment include a debit account selector 406a for a debit account linked to the user payment service provider account, a credit account selector 406b for a credit account linked to the user payment service provider account, and an FSA account selector 406c for an FSA account linked to the user payment service provider account. A cash selector 406d is also provided to allow the user to indicate that the payment for the bill will be made in cash. While a few examples have been provided, one of skill in the art will recognize that any payment method may be available to the user to pay for the bill received from the merchant device. The user may use the payment method selection screen 400 to select any of a plurality of payment methods for paying the bill received from the merchant device. As such, the user may select a user FSA to pay for the bill by selecting the FSA selector 406c, or may select a non-FSA to pay for the bill by selecting the selectors 406a, 406b, or 406d, and that selection will be stored by the payment service provider. As discussed above, in non-illustrated embodiment, the user may be presented with a bill (e.g., on a merchant device at a merchant location, through the mail, etc.) and may provide a particular account to pay for that bill by providing a payment card or payment details to the merchant (e.g., over the phone, over a website, etc.)

As discussed in further detail below, the payment service provider or system provider may operate to determine whether items in a bill received from the merchant are qualified expenses for a user FSA. As such, a user may designate a non-FSA to pay for the bill, and in some examples the payment service provider device or system provider device may detect items in the bill that are FSA qualified expenses and inform the user that those items may be paid for using the user FSA, or in other examples may operate to automatically pay for those items using the user FSA (e.g., despite the selection of a non-FSA account.) Similarly, the user may designate an FSA to pay for the bill, and in some examples the payment service provider device or system provider device may detect items in the bill that are not FSA qualified expenses and inform the user that those items should be paid for using non-FSAs, or in other examples may operate to automatically pay for those items using non-FSAs of the user (e.g., despite the selection of an FSA account.)

Referring now to FIG. 5, the user device 200 is illustrated displaying a bill screen 500 for the bill received from the merchant device. The bill screen 500 includes a plurality of item details 502, 504, 506, and 508 as well as a payment due section 510. The item details 302 include details for a prescription medication purchase 502a that, in the illustrated embodiment, includes a $425.89 charge and an FSA qualified expense indicator 502b. The item details 504 include details for a syringe purchase 504a that, in the illustrated embodiment, includes a $12.99 charge and an FSA qualified expense indicator 504b. The item details 506 include details for a prescription medication purchase 506a that, in the illustrated embodiment, includes a $182.00 charge and an FSA qualified expense indicator 506b. The item details 508 include details for a non-prescription medication purchase 508a that, in the illustrated embodiment, includes a $40.00 charge and an FSA qualified expense indicator 508b. In some embodiments, at least some of the FSA qualified expense indicators 502b, 504b, 506b, and 508b may be provided pre-selected by the merchant with the bill such that FSA qualified expenses are indicated (e.g., as with the prescription medication purchase 502a and the prescription medication purchase 506a.) The user may then select or de-select the FSA qualified expense indicators 502b, 504b, 506b, and 508b to indicate which items on the bill they would like paid for using their user FSA. In other embodiments, the FSA qualified expense indicators 502b, 504b, 506b, and 508b may be provided un-selected, and the user may then select the FSA qualified expense indicators 502b, 504b, 506b, and 508b to indicate which items on the bill they would like paid for using their user FSA.

The payment due section 510 includes total 510a ($660.88) that is determined by adding the price of each of the purchases 502a, 504a, 506a, and 508a, an insurance payment 510b ($400.00) that indicates an amount of the total 510a that is paid for by an insurance provider of the user, and a payment amount 510c ($260.88) that indicates and amount owed by the user. Thus, the bill received by the user details a plurality of items and different costs associated with those items, and as discussed below, some of those items may be qualified expenses for which payment using an FSA is allowed, while some of those items may be unqualified expenses for which payment using an FSA is not allowed. For example, qualified expenses for which payment using an FSA is allowed may include prescription medication expenses that are not paid for by insurance (e.g., deductibles, copayments, and coinsurance for the user's insurance), and thus in the illustrated embodiment, the portions of the prescription medication purchases 502a and 506a that are the responsibility of the user may be qualified expenses for which payment using the user FSA is allowed, while the purchases 504a and 508a may be unqualified expenses for which payment using the user FSA is not allowed.

At block 104 of the method 100, the user may select a pay button 512 provided on the bill screen 500 to send a purchase request to make a purchase from the merchant that will result in the payment of the user payment amount 510c of the bill, discussed in further detail below. In an embodiment, the selection of the payment method using the payment method selection screen 400 and the selection of the pay button 512 on the bill screen 500 results in the user device 200 sending an instruction over the network to the payment service provider device or system provider device that includes user information (e.g., a user name, user password, user payment service provider account identifier, mobile user device phone number, and/or a variety of other user information known in the art) and a purchase request to make the purchase from the merchant that may include merchant information (e.g., identifying the merchant, a merchant account, information associated with the bill, etc.) and the payment method selected.

While a few examples of the receiving of user information and a purchase request from a user to make a purchase from a merchant (that have occurred in response to the user receiving a bill from the merchant) have been described, those examples are not meant to be limiting. As discussed above, the user information and purchase request may be received in response to the user using a payment card or other payment device to make a purchase from a merchant, and one of skill in the art in possession of the present disclosure will recognize that user information and purchase requests may be received at block 104 in response to a wide variety of other scenarios known in the art that will fall within the scope of the present disclosure.

The method 100 then proceeds to block 106 where it is determined that at least one qualified expense is associated with the purchase. In an embodiment, upon receipt of the purchase request to make the purchase from the merchant, the payment service provider device or system provider device may review the details of the purchase (e.g., the itemized bills as illustrated in FIGS. 3 and 5) to determine if each of the items in the purchase are associated with at least one qualified expense. In some embodiments, block 106 may be performed for each purchase made by the user, regardless of the funding account used to make the purchase. As such, in one example, any purchase made by a user may be reviewed by the system provider device to determine if items in that purchase are qualified expenses that may be paid for with the user FSA. In some embodiments, block 106 may be performed for purchases made by the user using the user FSA. As such, in on example, the user may be required to indicate that the user FSA should be used to pay for a purchase before the system provider device will review the items in that purchase to determine whether they are qualified expenses that may be paid for using the user FSA. In some embodiments, the determination that at least one qualified expense is associated with the purchase may include reviewing the qualified expense indicators provided by the merchant and/or the user. In other embodiments, the determination that at least one qualified expense is associated with the purchase may include reviewing each item in the purchase request to determine whether any of those items are qualified expenses for an FSA (e.g., by comparing the items in the purchase request to a database of qualified expenses for an FSA.) In some embodiments, items indicated as a qualified expense by the merchant or user may be verified as qualified expenses at block 106 by comparing those items designated as qualified expenses in the purchase request to a database of qualified expenses for an FSA.

Thus, at block 106, the payment service provider device or system provider device determines that at least one qualified expense is associated with the purchase for which the purchase request was received at block 104. For example, referring to the embodiment illustrated in FIG. 3, the payment service provider device or system provider device may review the bill associated with the bill screen 300 and determine that the portions 302c and 304c of the total charges 302a and 304a, respectively, that are the responsibility of the user are qualified expenses for which payment using the user FSA is allowed, while the total charge 306a is an unqualified expense for which payment using the user FSA is not allowed. In another example, referring to the embodiment illustrated in FIG. 5, the payment service provider device or system provider device may review the bill associated with the bill screen 500 and determine that the purchases 502a and 506a that are the responsibility of the user are qualified expenses for which payment using the user FSA is allowed, while the purchases 504a and 508a are unqualified expenses for which payment using the user FSA is not allowed.

In an embodiment of block 106, the payment service provider device or system provider device may review the bill associated with the purchase request for accuracy with regard to the calculations used to determine amounts covered by the insurance provider of the user, the calculations used to determine amounts that are the responsibility of the user, and any designations of qualified expenses. In the event that a discrepancy is discovered, the bill may be sent back to the merchant device so that discrepancy may be corrected. Thus, errors in determining the amount covered by the insurance provider of the user, the amount that is the responsibility of the user, the designations of qualified expenses, and/or any other details of the bill associated with the purchase request may be dealt with at block 106 through communications between the payment service provider device or system provider device and the merchant device. Following the performance of block 106, the payment service provider device or system provider device has determined which items in the purchase request received at block 104 are qualified expenses for which payment using the user FSA is allowed, along with which items are unqualified expenses for which payment using the user FSA is not allowed.

In some embodiments, the payment service provider device or system provider device may access Application Programming Interfaces (APIs) provided by the merchant device to compare the items charged to the user in the bill to similar charges for similar items to other users associated with the merchant, which allows the payment service provider device to determine if the items are typically billed as qualified expenses, how items indicated as non-qualified expenses are typically billed, whether extra items included in the bill were needed and used, etc. For example, with reference to the bill screen 300, the payment service provider device or system provider device may access a database of the merchant device using APIs provided by the merchant to determine that a wisdom teeth procedure is typically associated with the anesthetic procedure, but not typically associated with the mouth wash, and thus determine that the mouth wash charges are not qualified expenses that may be paid for using the user FSA.

The method 100 then proceeds to block 108 where the merchant is paid for the portion of the purchase associated with the at least one qualified expense using the user FSA. In an embodiment, at block 108, the payment service provider device or system provider device transfers funds from the user FSA to the merchant account in an amount that is sufficient to pay for the items in the purchase request that were determined to be qualified expenses at block 106. In addition, the payment service provider device or system provider device may transfers funds from a non-FSA secondary user account of the user (e.g., a debit account, a credit account, etc.) to the merchant account in an amount that is sufficient to pay for the items in the purchase request that were determined to not be qualified expenses at block 106. In one embodiment of block 108, the payment service provider device or system provider sends an instruction to the FSA provider to transfer funds from the user FSA to the merchant account (which may be provided by the payment service provider, an account provider, and/or other merchant account provider known in the art), while sending an instruction to a secondary user account provider to transfer funds from the secondary user account to the merchant account such that the amount due on the purchase associated with the purchase request is paid to the merchant. In another embodiment, the user FSA is provided by the payment service provider device or system provider, and thus the payment service provider device or system provider transfers funds from the user FSA to the merchant account at block 108.

The method 100 then proceeds to block 110 where payment detail information is received from the merchant. In an embodiment, in response to making the payment to the merchant at block 108 for the purchase associated with the purchase request received at block 104, the merchant device may send, and the payment service provider device or system provider device may receive, payment detail information that may include a receipt that details the items associated with the payment (e.g., similarly as illustrated on the bill screens in FIGS. 3 and 5). In some embodiments, the payment detail information may include only the items purchased using the user FSA, while in other embodiments, the payment detail information may include each of the items purchased at block 108. In some embodiments, the payment detail information may include each of the items purchased at block 108 along with indicators of which of those items were purchased using the user FSA. At block 110, the payment service provider device or system provider device saves the payment detail information in a database in association with the user information, user payment service provider account, or other user indicator known in the art.

The method 100 then proceeds to block 112 where the payment detail information is provided to the FSA provider. In an embodiment, the payment service provider device or system provider device may provide the payment detail information, received at block 110 for the payment made at block 108, to the FSA provider over the network. In an embodiment, the provision of the payment detail information to the FSA provider may be performed in response to a request received by the payment service provider device or system provider device for the payment detail information from the FSA provider device. One of skill in the art in FSAs will recognize that FSA providers may request payment detail information associated with a payment made using a user FSA in some, but not all situations. For example, FSA providers may request payment detail information associated with payment made using an FSA in response to determining that payment is being made to a merchant for the first time, an item associated with that payment is being purchased for the first time, and/or in a variety of other payment detail information request scenarios known in the art. In other embodiments, the provision of the payment detail information to the FSA provider may be performed each time a payment is made using the user FSA. As discussed above, in some embodiments, the payment service provider or system provider may be the provider of the user FSA to the user. Thus, in some embodiments block 112 may be skipped.

The method 100 then proceeds to decision block 114 where it is determined whether an indication has been received from the FSA provider that one or more items in the payment detail information are unqualified expenses. As discussed above, FSAs are associated with qualified and unqualified expenses, and FSA providers may periodically audit purchases made using an FSA to determine whether the items paid for using the FSA are qualified expenses. Thus, in response to receiving the payment detail information following block 112, the FSA provider (which, in some embodiments, may be an auditing system in the payment service provider device or system provider device when the user FSA is provided by the payment service provider or system provider) may verify that each item paid for with the user FSA at block 108 is a qualified expense for the user FSA. In the event an item that was paid for using the user FSA is determined to be a non-qualified expense by the FSA provider, the FSA provider device may send an indication (e.g., an email or other indicator known in the art) of the items in the payment detail information that are unqualified expenses.

If, at decision block 114, the payment service provider device or system provider device receives the indication from the FSA provider that item(s) in the payment detail information are unqualified expenses, in some embodiment the payment service provider device or system provider device may first analyze those items to determine whether the indication received from the FSA provider at decision block 114 is correct. For example, to analyze the items indicated as unqualified expenses, the payment service provider device or system provider device may check those items against a database of qualified items, communicate with the merchant device about the items indicated by the FSA provider as unqualified expenses (e.g., to determine how those items are typically billed, to determine why those particular items were billed as qualified expenses, etc.), communicate with the FSA provider about the items indicated by the FSA provider as unqualified expenses, and/or perform a variety of other analysis tasks known in the art to determine whether the items indicated by the FSA provider as unqualified expenses are in fact unqualified expenses, or instead are qualified expenses.

If, at decision block 114, the payment service provider device or system provider device receives the indication from the FSA provider that item(s) in the payment detail information are unqualified expenses (and in some embodiments, if those items are verified as being unqualified expenses by the payment service provider device or system provider device), the method 100 then proceeds to block 116 where funds are transferred from a secondary user account to the user FSA. In an embodiment, at block 116 the payment service provider device or system provider device sends an instruction to a secondary user account provider to transfer funds from the secondary user account to the user FSA in an amount that covers the amount paid for using the user FSA at block 108 for the items indicated by the FSA provider to be unqualified expenses. Thus, in the event a payment is made from the user FSA for items that are unqualified expenses, the amount paid from the user FSA for those items will be reimbursed using a secondary user account.

If, at decision block 114, the payment service provider device or system provider device does not receive the indication from the FSA provider that item(s) in the payment detail information are unqualified expenses (or in some embodiments, if the items that are indicated as unqualified expenses by the FSA provider are then verified by the payment service provider device or system provider device as qualified expenses), or following the transferring of funds from the secondary user account to the user FSA at block 116, the method 100 then proceeds to block 118 where user FSA information is provided to the user.

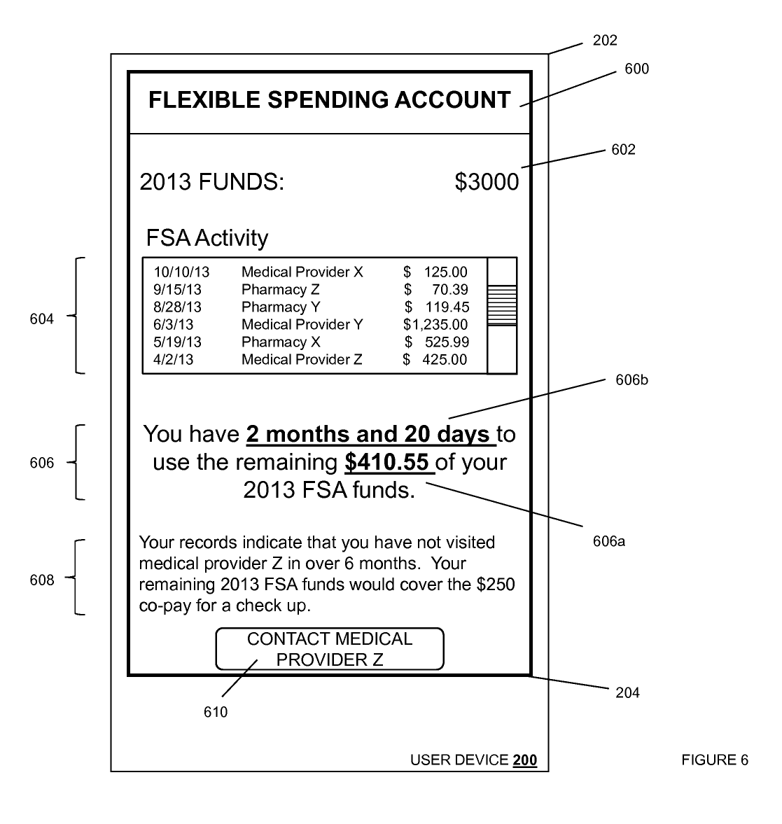

Referring now to FIG. 6, an embodiment of the provision of user FSA information to a user at block 118 is illustrated through the display on the user device 200 of a user FSA information screen 600. At block 118, the payment service provider device or system provider device may retrieve a variety of user FSA information related to the user FSA for display on the user FSA information screen 600. In the illustrated embodiment, at block 118 the payment service provider device or system provider device has retrieved current year funding information for the user FSA and provided user FSA funding information 602 on the user FSA information screen 600. As is known in the art of FSAs, the user may fund the user FSA with a funding amount that they must then spend by the end of a year (as defined by the user FSA), and the retrieval and display of the user FSA funding information 602 allows the user to quickly and easily review their current year funding of the user FSA.

In the illustrated embodiment, at block 118 the payment service provider device or system provider device has also retrieved a plurality of payment detail information for the user FSA and provided user FSA payment detail information 604 on the user FSA information screen 600. The user FSA payment detail information 604 may include payment detail information for a plurality of purchases made using the user FSA (e.g., payment detail information for each of the purchases made using the current year funds as detailed in the user FSA funding information 602), and the user may be able to scroll through and select a payment detail to determine a plurality of information about that purchase (e.g., in addition to the date, merchant, and payment information displayed in the user FSA payment detail information 604).

In the illustrated embodiment, at block 118 the payment service provider device or system provider device has also retrieved user FSA balance information 606 for the user FSA that includes a user FSA balance 606a and a time period 606b associated with the forfeiture of the user FSA balance 606a, and has provided the user FSA balance information 606 on the user FSA information screen 600. As discussed above, the user may fund the user FSA with a funding amount (e.g., as detailed in the user FSA funding information 602) that they must then spend by the end of a year (as defined by the user FSA), and the retrieval, determination, and provision of the user FSA balance information 606 allows the user to be quickly and easily informed of their current user FSA balance 606a and the time period 606b in which they must spend that user FSA balance 606a or have it subject to forfeiture.

In the illustrated embodiment, at block 118 the payment service provider device or system provider device has also analyzed the payment detail information associated with the user FSA (e.g., the user FSA payment detail information 604 for the current year of the user FSA, as well as previously purchased payment detail information for previous years in some embodiments) to determine at least one recommended merchant with which the user may wish to spend at least a portion of their user FSA balance 606a before the ending of the time period 606b, and has provided a recommended merchant section 608 on the user FSA information screen 600 along with a contact recommended merchant button 610. The recommended merchant section 608 may include information associated with the analysis of the payment detail information such as, for example, that the payment detail information indicates that the user has not visited the recommended merchant (e.g., a dentist) in a predetermined amount of time (e.g., 6 months), and that the user FSA balance 606a includes sufficient funds to cover a qualified expense (e.g., a $250 copayment) associated with a regularly scheduled visit to the recommended merchant (e.g., a dental check-up). The user may then select the contact recommended merchant button 610 to be connected to the recommended merchant (e.g., via a phone, a recommended merchant website, etc.) so that the user may schedule an appointment with the recommended merchant.

Thus, systems and methods for providing and/or managing FSAs have been described that provide a user FSA to a user such that the user may exert minimal or no effort to recognize the benefits of the user FSA, contrary to conventional FSA systems. In some embodiments, the user may simply make purchases from merchants, and the system provider may automatically analyze those purchases to determine whether any of those purchases are qualified expenses for the user FSA, and then use the funds in the user FSA to pay for the purchases that are qualified expenses. In other embodiments, the user may designate the user FSA to make payments for purchases, or may confirm that the user FSA should be used to pay for a purchase. Payment detail information such as, for example, receipts, are automatically collected by the system provider without any intervention by the user, and may be automatically provided to the FSA provider, or in response to the FSA provider indicating to the system provider that a purchase made using the FSA account was for an unqualified expense, also without any intervention from the user. The system provider may then operate to determine whether the indicated unqualified expense is or is not a qualified expense with little or no input from the user, and reimburse the user FSA with a secondary user account if it is determined that the indicated unqualified expense is actually an unqualified expense. The system provider may then periodically update the user on the status of funds in the user FSA, including making suggestions for qualified expense purchases such that the funds in the user FSA will not be forfeited.

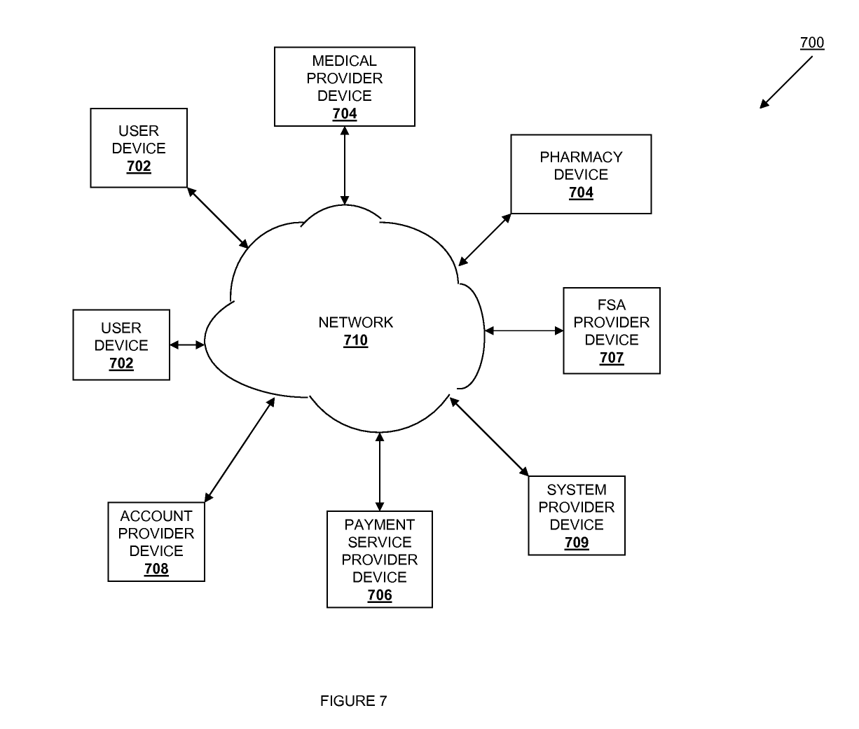

Referring now to FIG. 7, an embodiment of a network-based system 700 for implementing one or more processes described herein is illustrated. As shown, network-based system 700 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 7 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 700 illustrated in FIG. 7 includes a plurality of user devices 702, a plurality of merchant devices 704 (e.g., the medical provider devices and pharmacy devices in the illustrated embodiment), a payment service provider device 706, an FSA provider device 707, an account provider devices 708, and/or a system provider device 709 in communication over a network 710. Any of the user devices 702 may be the user device 200, discussed above. The merchant devices 704 may be the merchant devices discussed above and may be operated by the merchants discussed above. The payment service provider device 706 may be the payment service provider devices discussed above and may be operated by a payment service provider such as, for example, PayPal Inc. of San Jose, Calif. The FSA provider device 707 may be the FSA provider devices discussed above and may be operated by the FSA providers discussed above. The account provider device 708 may be the account provider devices discussed above and may be operated by the account providers discussed above such as, for example, credit card account providers, bank account providers, savings account providers, and a variety of other account providers known in the art. The system provider device 709 may be the FSA system devices discussed above and may be operated by the system providers discussed above.

The user devices 702, merchant devices 704, payment service provider device 706, FSA provider device 707, account provider device 708, and/or system provider device 709 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 700, and/or accessible over the network 710.

The network 710 may be implemented as a single network or a combination of multiple networks. For example, in various embodiments, the network 710 may include the Internet and/or one or more intranets, landline networks, wireless networks, and/or other appropriate types of networks.

The user device 702 may be implemented using any appropriate combination of hardware and/or software configured for wired and/or wireless communication over network 710. For example, in one embodiment, the user device 702 may be implemented as a personal computer of a user in communication with the Internet. In other embodiments, the user device 702 may be a smart phone, personal digital assistant (PDA), laptop computer, and/or other types of computing devices.

The user device 702 may include one or more browser applications which may be used, for example, to provide a convenient interface to permit the payer to browse information available over the network 710. For example, in one embodiment, the browser application may be implemented as a web browser configured to view information available over the Internet.

The user device 702 may also include one or more toolbar applications which may be used, for example, to provide user-side processing for performing desired tasks in response to operations selected by the user. In one embodiment, the toolbar application may display a user interface in connection with the browser application.

The user device 702 may further include other applications as may be desired in particular embodiments to provide desired features to the user device 702. In particular, the other applications may include a payment application for payments assisted by a payment service provider through the payment service provider device 706. The other applications may also include security applications for implementing user-side security features, programmatic user applications for interfacing with appropriate application programming interfaces (APIs) over the network 710, or other types of applications. Email and/or text applications may also be included, which allow the user to send and receive emails and/or text messages through the network 710. The user device 702 includes one or more user and/or device identifiers which may be implemented, for example, as operating system registry entries, cookies associated with the browser application, identifiers associated with hardware of the user device 702, or other appropriate identifiers, such as a phone number. In one embodiment, the user identifier may be used by the payment service provider device 706, the FSA provider device 707, the account provider device 708, and the system provider device 709 to associate the user with a particular account as further described herein.

The merchant devices 704 may be maintained, for example, by a conventional or on-line merchants, conventional or digital goods sellers, individual sellers, and/or application developer offering various products and/or services in exchange for payment to be received conventionally or over the network 710. In this regard, the merchant device 704 may include a database identifying available products and/or services (e.g., collectively referred to as items) which may be made available for viewing and purchase by the user.

The merchant devices 704 also include a checkout application which may be configured to facilitate the purchase by the payer of items. The checkout application may be configured to accept payment information from the user through the user device 702, the account provider through the account provider device 708, the FSA provider through the FSA provider device 708, the system provider through the system provider device 709, and/or from the payment service provider through the payment service provider device 706 over the network 710.

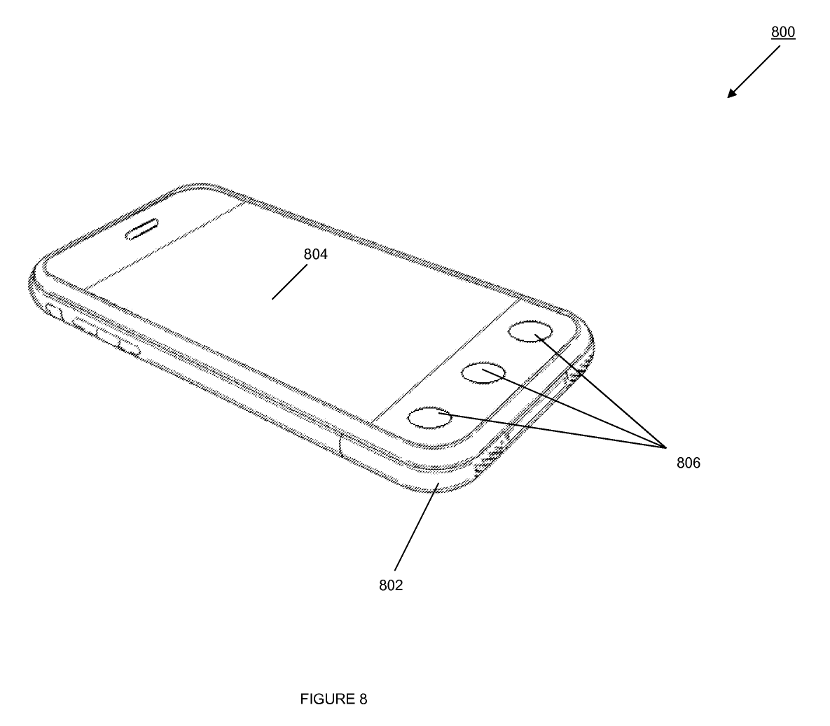

Referring now to FIG. 8, an embodiment of a user device 800 is illustrated. The user device 800 may be the user devices 200 and/or 702. The user device 800 includes a chassis 802 having a display 804 and an input device including the display 804 and a plurality of input buttons 806. One of skill in the art will recognize that the user device 800 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

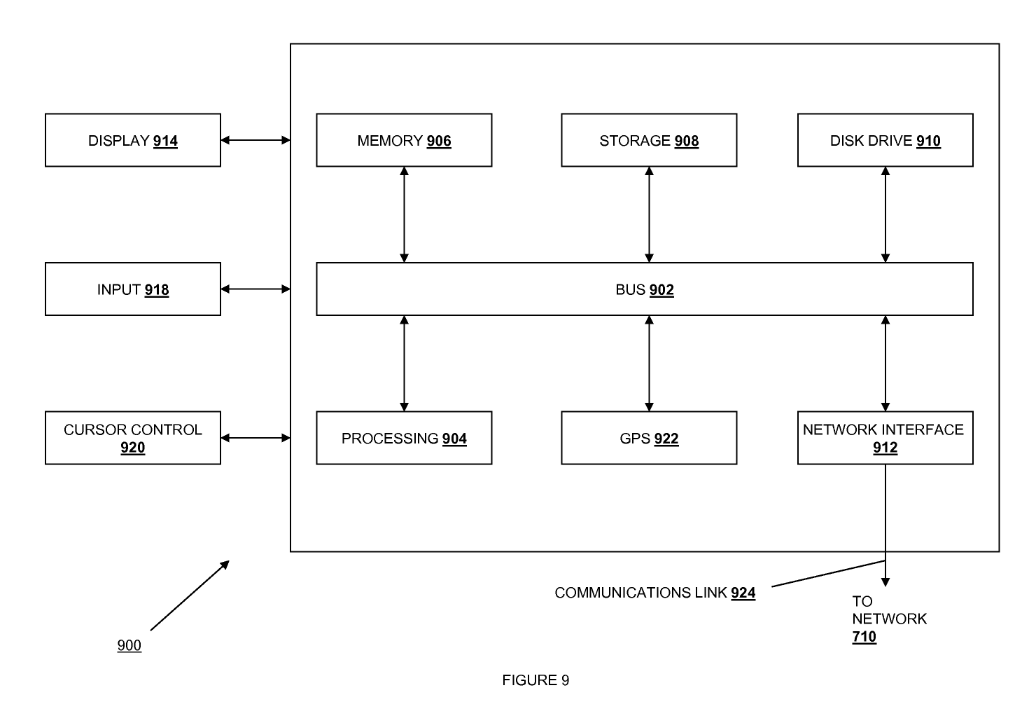

Referring now to FIG. 9, an embodiment of a computer system 900 suitable for implementing, for example, the user devices 200, 702, and/or 800, the merchant devices 704, the payment service provider device 706, the FSA provider device 707, the account provider device 708, and/or the system provider device 709, is illustrated. It should be appreciated that other devices utilized by users, merchants, payment service providers, FSA providers, account providers, and system providers in the FSA provision system discussed above may be implemented as the computer system 900 in a manner as follows.

In accordance with various embodiments of the present disclosure, computer system 900, such as a computer and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 918 (e.g., keyboard, keypad, or virtual keyboard), a cursor control component 920 (e.g., mouse, pointer, or trackball), and/or a location determination component 922 (e.g., a Global Positioning System (GPS) device as illustrated, a cell tower triangulation device, and/or a variety of other location determination devices known in the art.) In one implementation, the disk drive component 910 may comprise a database having one or more disk drive components.

In accordance with embodiments of the present disclosure, the computer system 900 performs specific operations by the processor 904 executing one or more sequences of instructions contained in the memory component 906, such as described herein with respect to the user device 200, 702, and 800, the merchant device(s) 704, the payment service provider device 706, the FSA provider device 707, the account provider device(s) 708, and/or the system provider device 709. Such instructions may be read into the system memory component 906 from another computer readable medium, such as the static storage component 908 or the disk drive component 910. In other embodiments, hard-wired circuitry may be used in place of or in combination with software instructions to implement the present disclosure.

Logic may be encoded in a computer readable medium, which may refer to any medium that participates in providing instructions to the processor 904 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 910, volatile media includes dynamic memory, such as the system memory component 906, and transmission media includes coaxial cables, copper wire, and fiber optics, including wires that comprise the bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 900. In various other embodiments of the present disclosure, a plurality of the computer systems 900 coupled by a communication link 924 to the network 710 (e.g., such as a LAN, WLAN, PTSN, and/or various other wired or wireless networks, including telecommunications, mobile, and cellular phone networks) may perform instruction sequences to practice the present disclosure in coordination with one another.

The computer system 900 may transmit and receive messages, data, information and instructions, including one or more programs (i.e., application code) through the communication link 924 and the network interface component 912. The network interface component 912 may include an antenna, either separate or integrated, to enable transmission and reception via the communication link 924. Received program code may be executed by processor 904 as received and/or stored in disk drive component 910 or some other non-volatile storage component for execution.

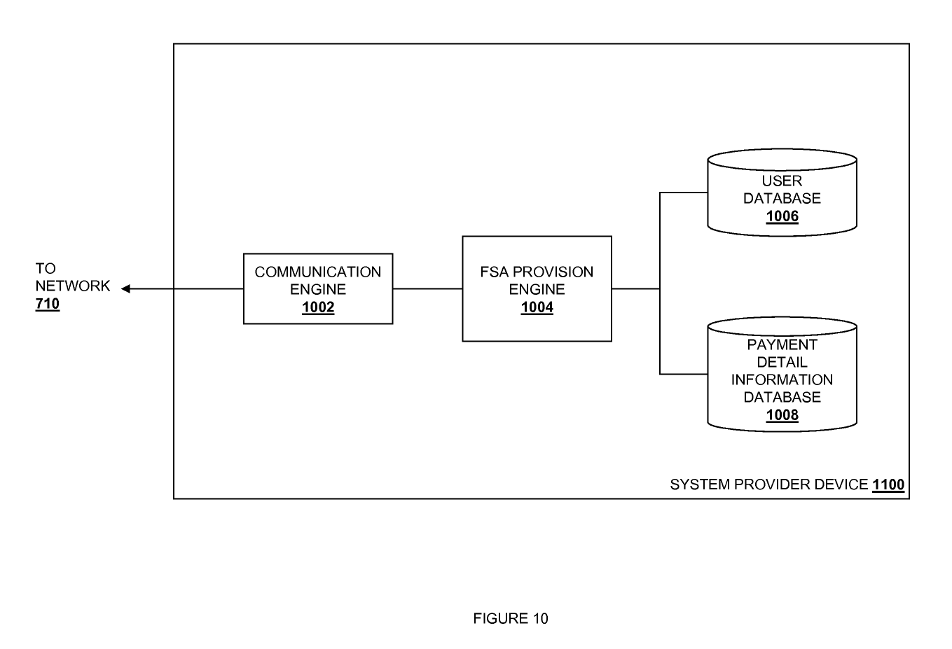

Referring now to FIG. 10, an embodiment of a system provider device 1000 is illustrated. In an embodiment, the device 1000 may be the payment service provider device 70, the FSA provider device 707, and/or the system provider devices discussed above. The device 1000 includes a communication engine 1002 that is coupled to the network 710 and to an FSA provision engine 1004 that is coupled to a user database 1006 storing information about a plurality of users and a payment detail information database 1008 storing payment detail information associated with user FSAs. The communication engine 1002 may be software or instructions stored on a computer-readable medium that allows the device 1000 to send and receive information over the network 710. The FSA provision engine 1004 may be software or instructions stored on a computer-readable medium that is operable to receive user information and purchase requests, make payment using user FSAs, receive payment detail information and store that payment detail information in the payment detail information database 1008, provide payment detail information to an FSA provider device, receive indications that a payment made for a purchase using the user FSA is an unqualified expense, transfer funds from a secondary user account identified in the user database to the user FSA, determine that qualified expenses are associated with a purchase, retrieve user FSA balances, determine time periods associated with a forfeiture of a user FSA balance, analyze payment detail information and provide a recommended merchant, and provide any of the other functionality that is discussed above. While the databases 1006 and 1008 have been illustrated as located in the device 1000, one of skill in the art will recognize that it may be connected to the FSA provision engine 1004 through the network 710 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on users and merchants; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing user information that is associated with a user flexible spending account (FSA) provided by an FSA provider;
one or more hardware processors coupled to the memory and operable to read instructions from the memory to perform the steps of:
receiving, over a network from a user device, the user information and a purchase request to make a purchase from a merchant;
making a payment for at least a portion of the purchase by transferring funds over the network from the user FSA associated with the user information to a merchant account associated with the merchant;
receiving payment detail information over the network from a merchant device associated with the merchant in response to making the payment; and
providing the payment detail information over the network to an FSA provider device associated with the FSA provider.

2. The system of claim 1, wherein the one or more hardware processors are operable to read instructions from the memory to perform the steps of:
receiving, over the network from the FSA provider device, an indication that at least one item in the payment detail information is an unqualified expense; and
transferring, over the network from a secondary user account associated with the user information, funds associated with the at least one item that is an unqualified expense to the user FSA.

3. The system of claim 1, wherein the one or more processors are operable to read instructions from the memory to perform the steps of:
reviewing the purchase request and, in response, determining that at least one qualified expense is associated with the purchase, wherein the payment for at least the portion of the purchase includes a payment for the at least one qualified expense.

4. The system of claim 1, wherein the one or more processors are operable to read instructions from the memory to perform the steps of:
storing the payment detail information in the non-transitory memory in association with the user information and a plurality of previous purchase payment detail information associated with previous purchases; and
providing, over the network for display on the user device, the payment detail information and the previous purchase payment detail information.

5. The system of claim 1, wherein the one or more processors are operable to read instructions from the memory to perform the steps of:
retrieving, over the network from the FSA provider, a user FSA balance; and
providing, over the network for display on the user device, the user FSA balance.

6. The system of claim 5, wherein the one or more processors are operable to read instructions from the memory to perform the steps of:
determining a time period associated with a forfeiture of the user FSA balance;
analyzing the payment detail information and a plurality of previous purchase payment detail information associated with previous purchases; and
providing, over the network on the user device, a recommended merchant at which to spend at least a portion of the user FSA balance based on the analyzing of the payment detail information and the plurality of previous purchase payment detail information.

7. A method for providing a flexible spending account (FSA), comprising:
receiving, over a network from a user device, user information and a purchase request to make a purchase from a merchant;
making a payment for at least a portion of the purchase by transferring funds over the network from a user FSA associated with the user information to a merchant account associated with the merchant;
receiving payment detail information over the network from a merchant device associated with the merchant in response to making the payment; and
providing the payment detail information over the network to an FSA provider device associated with an FSA provider.

8. The method of claim 7, further comprising:
receiving, over the network from the FSA provider device, an indication that at least one item in the payment detail information is an unqualified expense; and
transferring, over the network from a secondary user account associated with the user information, funds associated with the at least one item that is an unqualified expense to the user FSA.

9. The method of claim 7, further comprising:
reviewing the purchase request and, in response, determining that at least one qualified expense is associated with the purchase, wherein the payment for at least the portion of the purchase includes a payment for the at least one qualified expense.

10. The method of claim 7, further comprising:
storing the payment detail information in a database in association with the user information and a plurality of previous purchase payment detail information associated with previous purchases; and
providing, over the network for display on the user device, the payment detail information and the previous purchase payment detail information.

11. The method of claim 7, further comprising:
retrieving, over the network from the FSA provider, a user FSA balance; and
providing, over the network for display on the user device, the user FSA balance.

12. The method of claim 11, further comprising:
determining a time period associated with a forfeiture of the user FSA balance; and
providing, over the network for display on the user device, the time period associated with the forfeiture of the user FSA balance.

13. The method of claim 12, further comprising:
analyzing the payment detail information and a plurality of previous purchase payment detail information associated with previous purchases; and
providing, over the network on the user device, a recommended merchant at which to spend at least a portion of the user FSA balance based on the analyzing of the payment detail information and the plurality of previous purchase payment detail information.

14. A non-transitory machine-readable medium comprising a plurality of machine-readable instructions which, when executed by one or more processors, are adapted to cause the one or more processors to perform a method comprising:
receiving, over a network from a user device, user information and a purchase request to make a purchase from a merchant;
making a payment for at least a portion of the purchase by transferring funds over the network from a user FSA associated with the user information to a merchant account associated with the merchant;
receiving payment detail information over the network from a merchant device associated with the merchant in response to making the payment; and
providing the payment detail information over the network to an FSA provider device associated with an FSA provider.

15. The non-transitory machine-readable medium of claim 14, wherein the method further comprises:
receiving, over the network from the FSA provider device, an indication that at least one item in the payment detail information is an unqualified expense; and
transferring, over the network from a secondary user account associated with the user information, funds associated with the at least one item that is an unqualified expense to the user FSA.

16. The non-transitory machine-readable medium of claim 14, wherein the method further comprises:
reviewing the purchase request and, in response, determining that at least one qualified expense is associated with the purchase, wherein the payment for at least the portion of the purchase includes a payment for the at least one qualified expense.

17. The non-transitory machine-readable medium of claim 14, wherein the method further comprises:
storing the payment detail information in a database in association with the user information and a plurality of previous purchase payment detail information associated with previous purchases; and
providing, over the network for display on the user device, the payment detail information and the previous purchase payment detail information.

18. The non-transitory machine-readable medium of claim 14, wherein the method further comprises:
retrieving, over the network from the FSA provider, a user FSA balance; and
providing, over the network for display on the user device, the user FSA balance.

19. The non-transitory machine-readable medium of claim 18, wherein the method further comprises:
determining a time period associated with a forfeiture of the user FSA balance; and
providing, over the network for display on the user device, the time period associated with the forfeiture of the user FSA balance.

20. The non-transitory machine-readable medium of claim 19, wherein the method further comprises:
analyzing the payment detail information and a plurality of previous purchase payment detail information associated with previous purchases; and
providing, over the network on the user device, a recommended merchant at which to spend at least a portion of the user FSA balance based on the analyzing of the payment detail information and the plurality of previous purchase payment detail information.
